(19) United States
(12) Patent Application Publication
(10) Pub. No.: US 2009/0328142 A1
(43) Pub. Date: Dec. 31, 2009

(54) Systems and Methods for Webpage Verification Using Data-Hiding Technology

(75) Inventors: Shih-Chun WANG, Niaosong Township (TW); Chun-Lung HUANG, Jhubei City (TW); Chu-Fei CHANG, Hsinchu City (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Industrial Technology Research Institute, Hsinchu (TW)

(21) Appl. No.: 12/165,520

(22) Filed: Jun. 30, 2008

(51) Int. Cl. G06F 21/00

(52) U.S. Cl. 726/2

(57) ABSTRACT

A system for webpage verification comprises an authentication module configured to authenticate a user identifier if the user identifier is unique in the system, the user identifier being related to the identity of a user, a data-hiding module configured to generate a first data-hidden object based on a unique user identifier, at least one webpage identifier and a base object in accordance with a data-hiding algorithm, each of the at least one webpage identifiers being related to the identity of one of at least one webpage of the user, a memory module to store at least one of the said user identifier, the at least one webpage identifier, the base object, and the required parameters of data-hiding algorithm, and a verification module configured to retrieve the first data-hidden object from one of the at least one webpage based on one of the at least one webpage identifier, retrieve a user identifier and all of the webpage identifiers from the memory module based on the one webpage identifier, generate a second data-hidden object based on the retrieved webpage identifiers, the retrieved user identifier and the base object, and compare the first data-hidden object with the second data-hidden object.

### BACKGROUND

The present invention relates to webpage verification and, more particularly, to systems and methods for webpage verification using data-hiding technology.

Network communication progresses with various revolutionary technologies, which may increase network throughput and improve communication quality and reliability. As a result, various on-line activities now are feasible through electronic communication. A user may share his/her own information, for example, photos, articles and so forth, on a website or webpage by uploading such information to a server that is dedicated to manage the website. As the interest in network communications increases, however, internet crime such as illegal downloading, unauthorized use of private photos or articles, phishing, identity theft and credit card frauds may increase. To protect users from the potential risks, a verification mechanism may be employed. For example, a MicroID verification method, which is known as a verification model based on text-contained information, has been used to conduct website verification. Normally, such text-contained information may be relevant to a website or webpage to be identified and may include, for example, a uniform resource identifier of the website or webpage.

FIG. 1 is a schematic diagram illustrating a system 1 based on MicroID verification. Referring to FIG. 1, the system 1 may include a server 14, a website or webpage 16 under the management of the server 14, an owner terminal 10 through which an owner of the webpage 16 may administrate his/her webpage 16, and a user terminal 12 through which a user may access the webpage 16. The owner of the webpage 16 may provide his/her personal information, such as e-mail address “user@email.com” (hereinafter referred to as “M1”) through the terminal 10 to the server 14. In the server 14, M1 and the uniform resource identifier (URI) “http://website.com” (hereinafter referred to as “URIA”) of the webpage 16 may be individually encrypted according to an algorithm, for example, a “sha1” algorithm. The encrypted M1 and URIA may then be combined and again be encrypted by the sha1 algorithm to “hash” a MicroID “MI1,” which may in turn be placed on the webpage 16. The owner may thus claim his/her ownership of the webpage 16 based on the MicroID MI1.

To verify whether a person with an e-mail address “M2” is the owner of the webpage 16, a third-party user may send the e-mail address “M2” together with URIA via the user terminal 12 to the server 14, which in turn may hash a MicroID “M12” based on the M2 and URIA. MI2 may then be compared with MI1 in the server 14. If MI2 matches MI1, the person with the e-mail address M2 is identified as the owner of the webpage 16.

Nevertheless, MicroIDs may be vulnerable to forgery. For example, a MicroID can be forged out of the e-mail address M1 and a forger's URI, say, for example, URIB. If the forged MicroID based on M1 and URIB is placed by the forger on a webpage with the URIB, unsuspecting users may mistake the forger for the owner (M1) by verifying the forged MicroID through the system 1 and illegal internet activities such as fraud and phishing may accordingly arise.

### SUMMARY

Examples of the present invention may provide a system for webpage verification, the system comprising an authentication module configured to authenticate a user identifier if the user identifier is unique in the system, the user identifier being related to the identity of a user, a data-hiding module configured to generate a first data-hidden object based on a unique user identifier, at least one webpage identifiers and a base object in accordance with a data-hiding algorithm, each of the at least one webpage identifier being related to the identity of one of at least one webpage of the user, a memory module to store at least one of the unique user identifier, the at least one webpage identifier, the base object, the required parameters of data-hiding algorithm, and a verification module configured to retrieve the first data-hidden object from one of the at least one webpage based on one of the at least one webpage identifiers, retrieve a user identifier and all of the webpage identifiers from the memory module based on the one webpage identifier, generate a second data-hidden object based on the retrieved webpage identifiers, the retrieved user identifier and the base object, and compare the first data-hidden object with the second data-hidden object.

Some examples of the present invention may also provide a system for webpage verification, the system comprising an authentication module configured to authenticate a user identifier if the user identifier is unique in the system, the user identifier being related to the identity of a user, a data-hiding module configured to generate a first data-hidden object based on a unique user identifier, at least one webpage identifier and a base object in accordance with a data-hiding algorithm, each of the at least one webpage identifier being related to the identity of one of at least one webpage of the user, a memory module to store at least one of the unique user identifier, the at least one webpage identifier, the base object, the required parameters of data-hiding algorithm, and a verification module configured to retrieve the first data-hidden object from one of the at least one webpage based on one of the at least one webpage identifier, extract a user identifier and all of the webpage identifiers from the first data-hidden object, retrieve a user identifier from the memory module based on the one webpage identifier and compare the extracted user identifier with the retrieved user identifier and identify whether the extracted webpage identifiers include the one webpage identifier.

Examples of the present invention may further provide a system for webpage verification, the system comprising an authentication module configured to authenticate a user identifier if the user identifier is unique in the system, the user identifier being related to the identity of a user, a data-hiding module configured to generate a first data-hidden object based on a unique user identifier, at least one webpage identifiers and a base object in accordance with a data-hiding algorithm, each of the at least one webpage identifier being related to the identity of one of at least one webpage of the user, and a verification module configured to receive a first webpage identifier, retrieve a second data-hidden object from a webpage based on the first webpage identifier, extract all of the webpage identifiers from the second data-hidden object, and identify whether the webpage identifiers extracted from the second data-hidden object include the first webpage identifier.

Other objects, advantages and novel features of the present invention will be drawn from the following detailed embodiments of the present invention with attached drawings, in which:

### BRIEF DESCRIPTION OF THE SEVERAL VIEWS OF THE DRAWINGS

The foregoing summary as well as the following detailed description of the preferred embodiments of the present invention will be better understood when read in conjunction with the appended drawings. For the purposes of illustrating the invention, there are shown in the drawings embodiments which are presently preferred. It is understood, however, that the invention is not limited to the precise arrangements and instrumentalities shown. In the drawings:

FIG. 1 is a schematic diagram illustrating a system based on MicroID verification;

FIG. 2A is a schematic diagram illustrating a system for webpage verification in accordance with an example of the present invention;

FIG. 2B is a block diagram illustrating exemplary operation of a service server of the system illustrated in FIG. 2A;

FIG. 3 is a schematic diagram illustrating a system for webpage verification in accordance with another example of the present invention;

FIGS. 4A to 4C are flow diagrams illustrating exemplary methods of webpage verification;

FIGS. 5A to 5D are flow diagrams illustrating other exemplary methods of webpage verification; and

FIGS. 6A and 6B are flow diagrams illustrating still other exemplary methods of webpage verification.

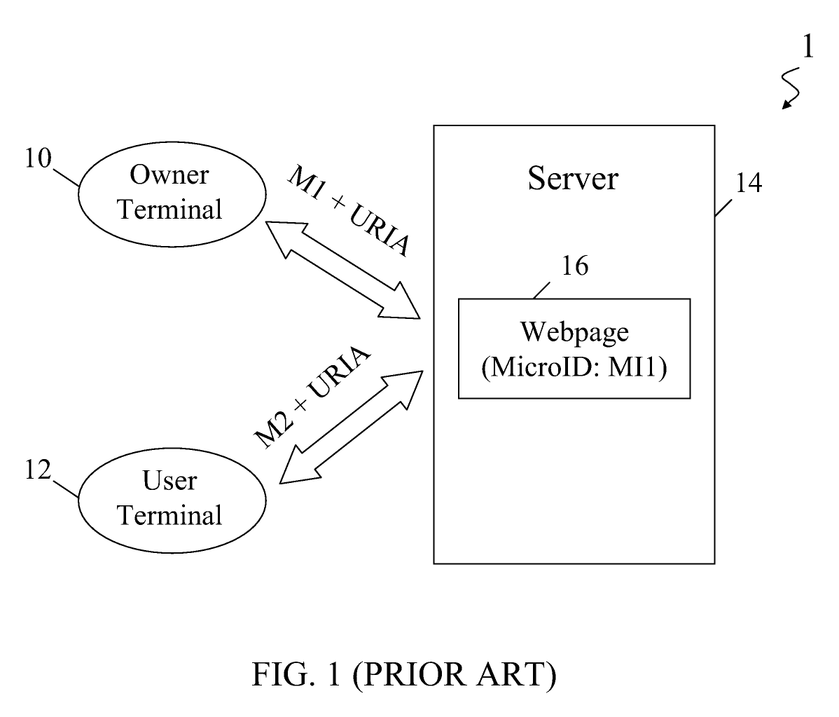

### DETAILED DESCRIPTION

Reference will now be made in detail to the present examples of embodiments of the invention illustrated in the accompanying drawings. Wherever possible, the same reference numbers will be used throughout the drawings to refer to the same or like portions.

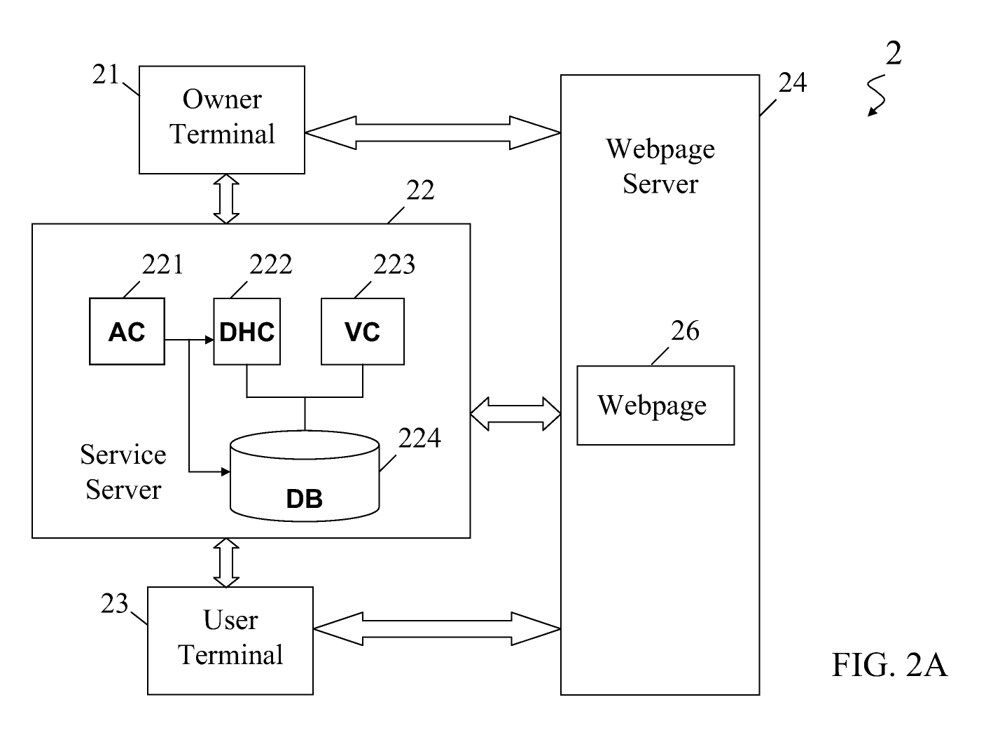

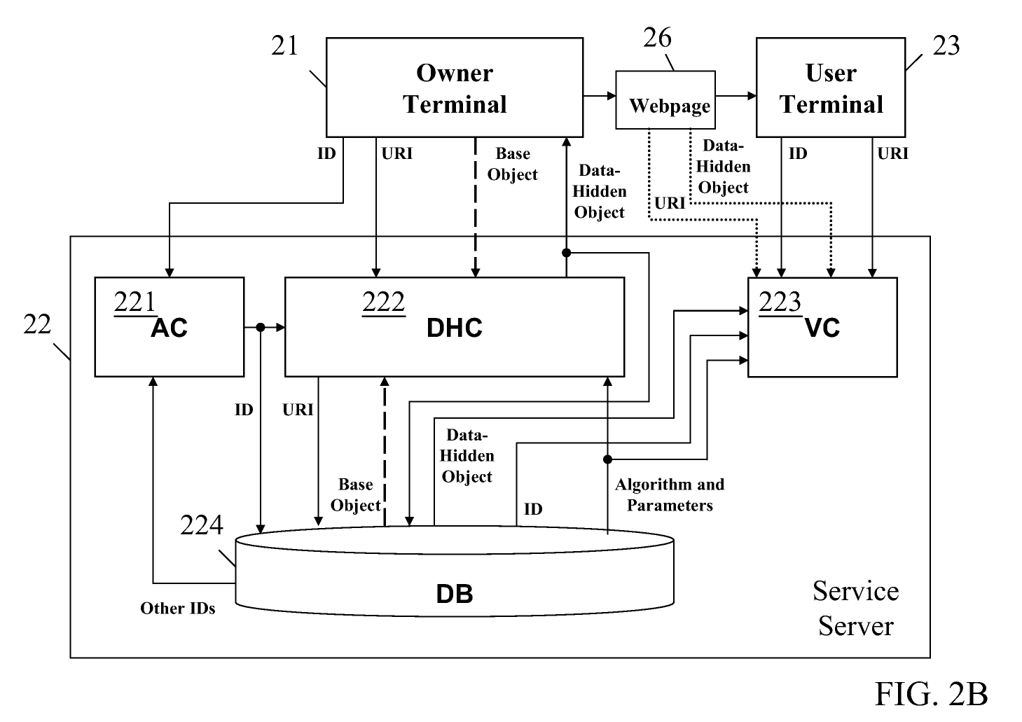

FIG. 2A is a schematic diagram illustrating a system 2 for webpage verification in accordance with an example of the present invention. Referring to FIG. 2A, the system 2 may include a service server 22, a webpage server 24, a user terminal 23 and an owner terminal 21. The service server 22 may be configured to support data encryption and verification. The webpage server 24 may be configured to manage uplink or downlink of media content such as image, text, audio, video and audio/video content on a webpage 26. Each of the service server 22 and the webpage server 24 may comprise a computer, a workstation or a workstation computer. A user may access the service server 22 and the webpage server 24 through the user terminal 23, and an owner who may have authority to administrate the webpage 26 established in the webpage server 24 may access the service server 22 and the webpage server 24 through the owner terminal 21. Each of the owner terminal 21 and the user terminal 23 may comprise but is not limited to one or more of a mobile phone, cell phone, personal digital assistant (PDA), personal computer (PC) or notebook, which may be configured to support communications over a network or the Internet.

The service server 22 may include an authentication module or authentication component (AC) 221, a data-hiding module or data-hiding component (DHC) 222, a verification module or verification component (VC) 223 and a memory module or database (DB) 224. The service server 22 may be configured to facilitate the owner of the webpage 26 to claim his/her ownership and the user to check the authenticity of the webpage 26. The components AC 221, DHC 222 and VC 223 may be implemented in hardware or software, in which the former may be more advantageous in view of operation speed while the latter may be more cost effective in view of design complexity. If implemented in hardware, these components 221 to 223 may include modules mounted in the service server 22. If implemented in software, these components 221 to 223 may include executable programs or applications installed in the service server 22. Operation of the system 2 will be discussed by reference to FIG. 2B below.

FIG. 2B is a block diagram illustrating exemplary operation of the service server 22 of the system 2 illustrated in FIG. 2A. Referring to FIG. 2B, AC 221 may be configured to receive a user identifier “ID” from a first user, i.e., the owner, via a first terminal, i.e., the owner terminal 21 and identify whether the user identifier is distinguishable from other user identifiers already registered with AC 221 and stored in DB 224 of the system 2. The user identifier related to the identity of the first user may be stored in DB 224 when authenticated. In one example, the user identifier may include but is not limited to an account number, with which the first user may use to login to the service server 22, an e-mail address, a mobile phone number or an OpenID identifier. OpenID may refer to an identity service, which allows a user to login to different websites or webpages using a single digital identity. The AC 221 may reject a user identifier if such a user identifier has been used by another user in the system 2 and may request the owner to provide another unique user identifier in order to distinguish himself/herself from other users in the system 2.

The DHC 222 may be configured to receive an authenticated user identifier from AC 221 and one or more webpage identifier “URI” from the first user. Each of the at least one webpage identifier may be related to the identity of a webpage of the first user, such as, for example, a universal resource identifier (URI) or universal resource locator (URL) of the webpage. In one example, the user identifier may include an e-mail address of the first user, e.g., “victor@yahoo.com,” and one of the at least one webpage identifier may include the URI of a webpage of the first user, e.g., http://myblog.example.com/victor.” The at least one webpage identifier may then be stored in a memory space in DB 224.

Based on the user identifier and the one or more webpage identifier, DHC 222 may generate a signature “S” in accordance with a first data-hiding algorithm and embed the signature S into a base object such as digital content including an image, audio or video in accordance with a second data-hiding algorithm. In one example, the first data-hiding algorithm may include the “sha1” algorithm and the second data-hiding algorithm may include but is not limited to a watermark algorithm. In other examples, however, DHC 222 may embed the user identifier and the at least one webpage identifier into a base object based on the second data-hiding algorithm. The base object may be provided by the first user (shown in a dashed line) or the service server 22 (shown in another dashed line). A data-hidden base object generated by DHC 222, in one example a “watermarked” object, may then be sent to the first user and stored in DB 224. Furthermore, the second data-hiding algorithm and, if any, the first data-hiding algorithm together with their relevant parameters may be stored in DB 224 to facilitate extraction of the user identifier from the signature S. The first user may subsequently place the data-hidden object on his/her one or more webpage including the webpage 26.

The VC 223 may be configured to, upon request by the first user, confirm the ownership of one of the at least one webpage and, upon request by a second user, verify whether one of the at least one webpage belongs to the first user. To confirm to the first user that he/she is the owner of the webpage 26, VC 223 may retrieve a first data-hidden object (shown in a dotted line) from the webpage 26. Furthermore, based on the URI of the webpage 26 (shown in another dotted line), VC 223 in one example may retrieve a user identifier corresponding thereto from DB 224, and in another example may receive a user identifier from the first user. Based on the URI of the webpage 26 and the retrieved or received user identifier, VC 223 may generate a second data-hidden object. The VC 223 may then identify whether the webpage 26 belongs to the first user in an object comparison process by comparing the first data-hidden object with the second data-hidden object.

In another example, VC 223 may retrieve a first data-hidden object from the webpage 26 and parse the first data-hidden object to extract a first user identifier and all webpage identifiers, and/or a first signature therefrom based on one or more of the first and second data-hiding algorithms stored in DB 224. Furthermore, based on the URI of the webpage 26, VC 223 may retrieve a second user identifier or a second signature corresponding to the URI of the webpage 26 from DB 224. The VC 223 may then identify whether the webpage 26 belongs to the first user in a data comparison process by comparing the extracted first user identifier with the retrieved second user identifier while comparing the extracted webpage identifier(s) with the URI of the webpage 26, and/or comparing the extracted first signature with the retrieved second signature.

To verify the authenticity of a webpage for the second user, VC 223 may receive an unidentified webpage identifier and an unidentified user identifier from the second user. Based on the unidentified webpage identifier, VC 223 may retrieve a first data-hidden object from a webpage. Furthermore, all webpage identifiers related to the unidentified user identifier may be retrieved from DB 224. Based on the retrieved webpage identifiers and the unidentified user identifier, VC 223 may generate a second data-hidden object and may then compare the first data-hidden object with the second data-hidden object in an object comparison process. Alternatively, VC 223 may extract a user identifier and all the webpage identifiers from the first data-hidden object, and then compare the extracted user identifier with the unidentified user identifier and identify whether the extracted webpage identifier(s) includes the unidentified webpage identifier in a data comparison process.

In another example, the second user may provide only an unidentified webpage identifier to VC 223 for an inquiry about the owner of a webpage. The VC 223 may retrieve a data-hidden object from a webpage based on the unidentified webpage identifier and then extract a user identifier, all the webpage identifiers and/or a first signature from the data-hidden object. Furthermore, the VC 223 may retrieve an ID and/or a second signature based on the unidentified webpage identifier from DB 224. The VC 223 may identify that the user with the extracted user identifier owns the webpage by comparing the extracted webpage identifier with the unidentified webpage identifier and by identifying whether the extracted webpage identifier(s) includes the unidentified webpage identifier and/or whether the first signature is identical with the second signature.

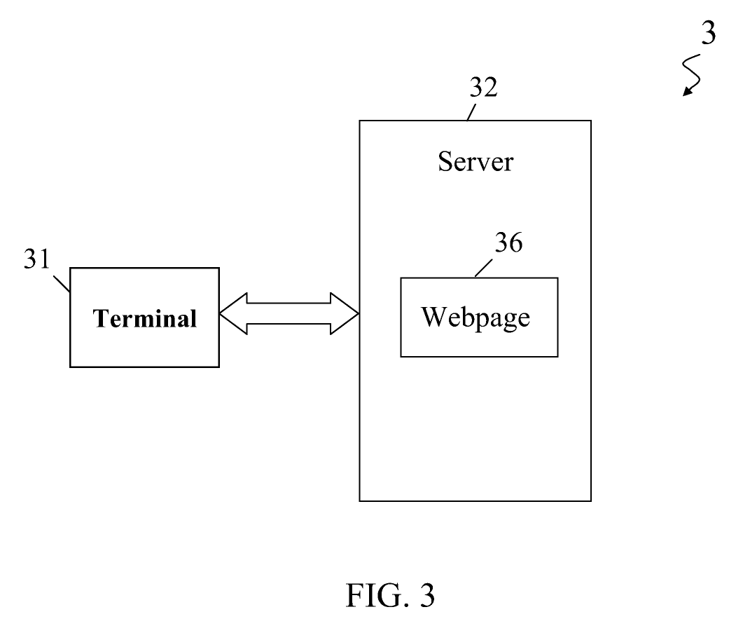

FIG. 3 is a schematic diagram illustrating a system 3 for webpage verification in accordance with another example of the present invention. Referring to FIG. 3, the system 3 may include a server 32, a webpage 36 and a terminal 31. The server 32 may be configured to support the functions of the service server 22 and the webpage server 24 described and illustrated with reference to FIG. 2A. The terminal 31 may be configured to facilitate an owner of the webpage 36 and a user of the system 3 to access the webpage 36.

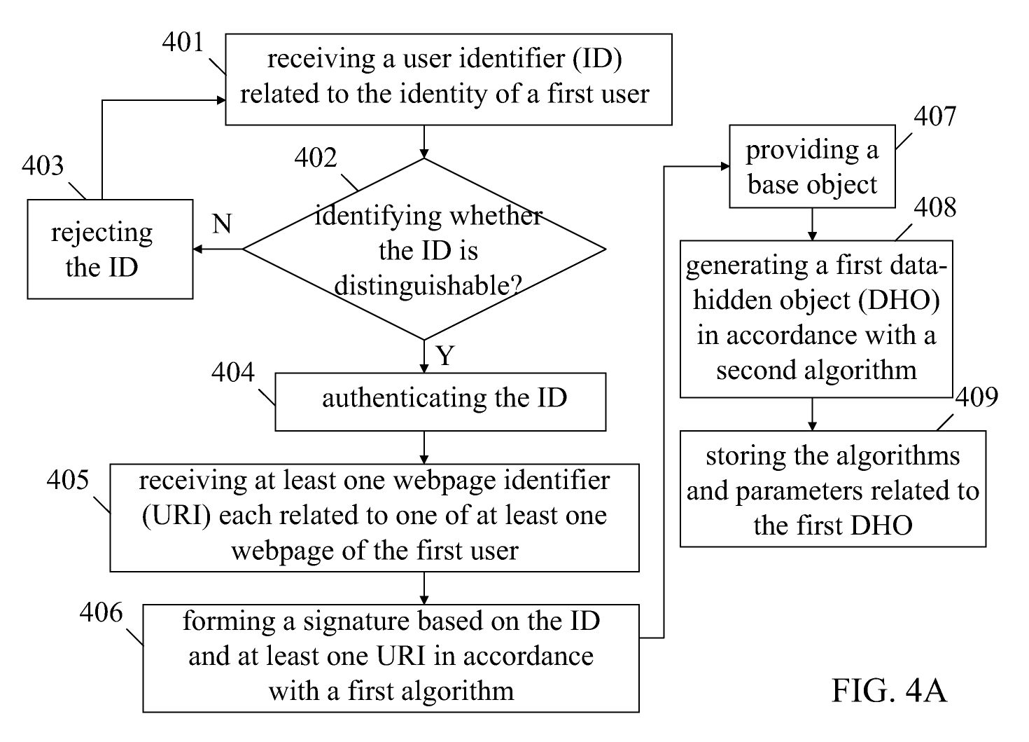

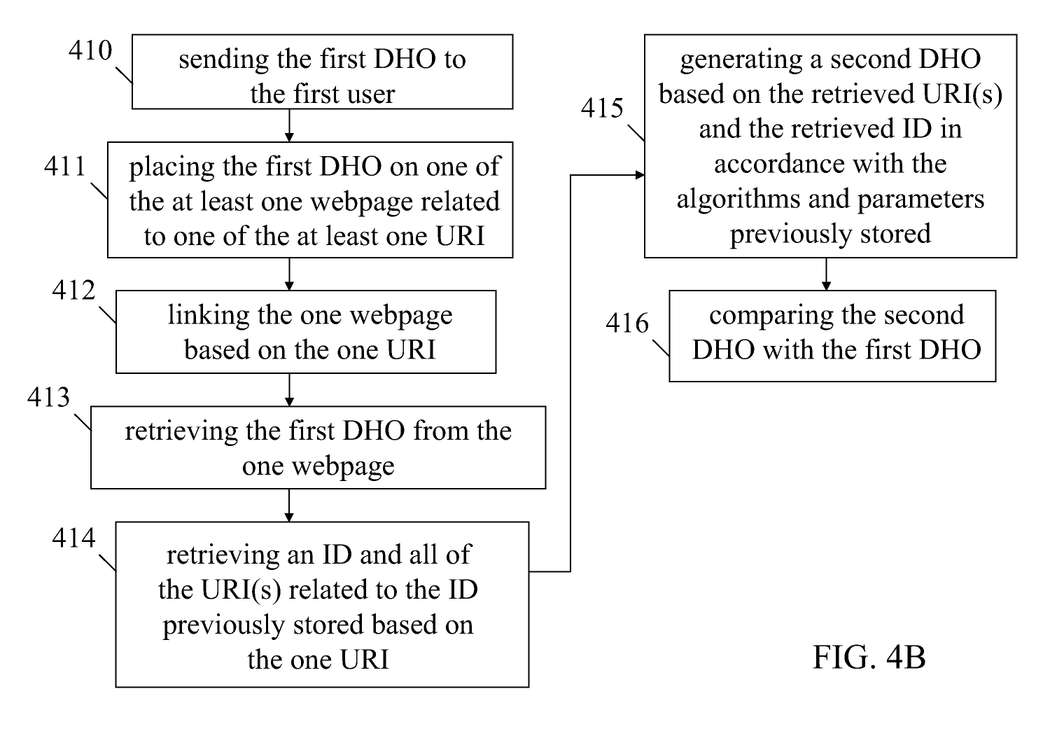

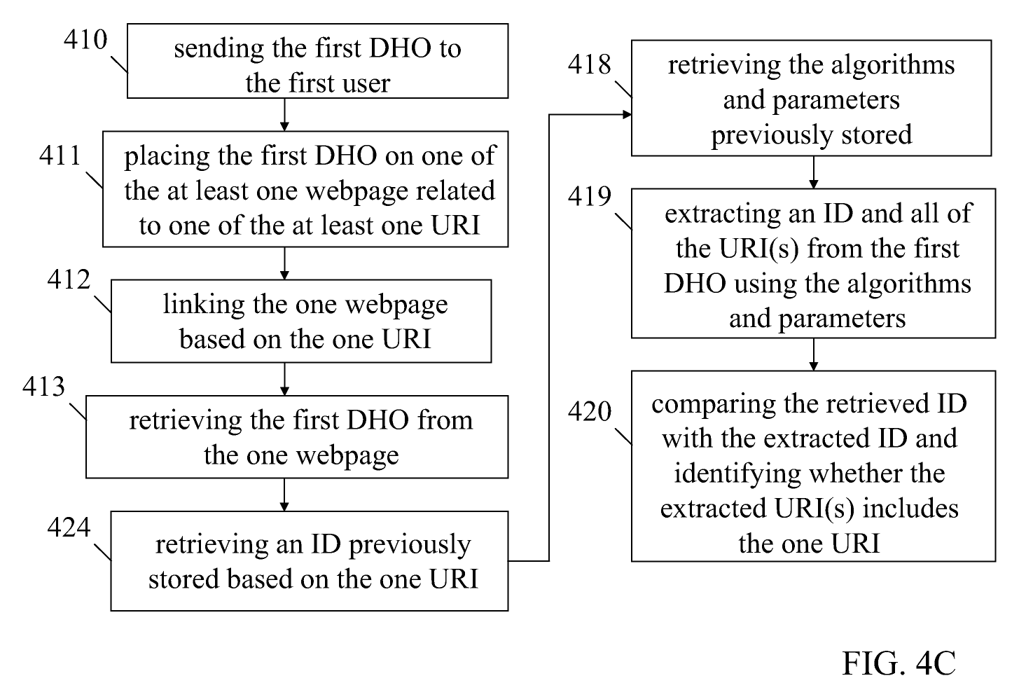

FIGS. 4A to 4C are flow diagrams illustrating exemplary methods of webpage verification. Referring to FIG. 4A, at step 401, a user identifier (ID) related to the identity of a first user may be received by a server. The server may include the service server 22 or the server 32 described and illustrated with reference to FIGS. 2A and 3, respectively. At step 402, it may be identified whether the ID is distinguishable from other user identifiers (IDs), which have been registered with the server. If not, at step 403, the ID may be rejected. The server may subsequently request a new ID from the first user. If confirmative, at step 404, the ID may be authenticated and then stored in the server.

Next, at step 405, at least one webpage identifier (denoted as URI) from the first user may be received by the server. Each of the at least one URI may be related to a universal resource identifier or universal resource locator of one of at least one webpage of the first user. At step 406, a signature based on the ID and the at least one URI may be formed by the server in accordance with a first data-hiding algorithm, for example, the “sha1” algorithm. At step 407, a base object may be provided by the first user or the server. At step 408, a first data-hidden object (DHO) may be generated by the server based on the signature and the base object in accordance with a second data-hiding algorithm, such as, for example, the watermark algorithm. In the present example, the ID and URI are formed into the signature, which in turn is embedded into the base object. In another example, the ID and URI may be directly embedded into the base object at step 408 using the second data-hiding algorithm without forming a signature at step 406. Subsequently, at step 409, the first algorithm, if any, and the second algorithm together with parameters required to perform the algorithms may be stored in the server.

Referring to FIG. 4B, the first DHO may be sent from the server to the first user at step 410. The first DHO may be placed by the first user on one or more of the at least one webpage related to the at least one URI at step 411. For simplicity, it is assumed that the first user places the first DHO on one of the at least one webpage with one of the at least one URI even though in reality the first user may place the first DHO on more than one of his/her webpages. The first user may claim his/her ownership of the one webpage through the following steps. At step 412, based on the one URI, which may be provided by the first user during the ownership claim process, the one webpage with the one URI may be linked. The first DHO may be retrieved from the one webpage at step 413. At step 414, an ID previously stored in the server may be retrieved based on the one URI and all of the URI(s) related to the ID may be retrieved from the server based on the ID. Next, at step 415, a second DHO may be generated by the server based on the retrieved ID and the retrieved URI(s) in accordance with the algorithms previously stored. At step 416, the first DHO and the second DHO may be compared with each other in an object comparison process in order to authenticate the ownership of the one webpage.

Referring to FIG. 4C, in another example, after step 413, an ID previously stored may be retrieved form the server based on the one URI at step 424. Furthermore, the first algorithm, if necessary, and the second algorithm together with the required parameters previously stored in the server may be retrieved at step 418. At step 419, an ID and all of the URI(s) may be extracted from the first DHO using the algorithms and the required parameters. Next, the ID retrieved at step 414 and the ID extracted at step 419 may be compared with each other while the one URI and the extracted URI(s) may be compared with each other to identify whether the extracted URI(s) includes the one URI at step 420 in a data comparison process.

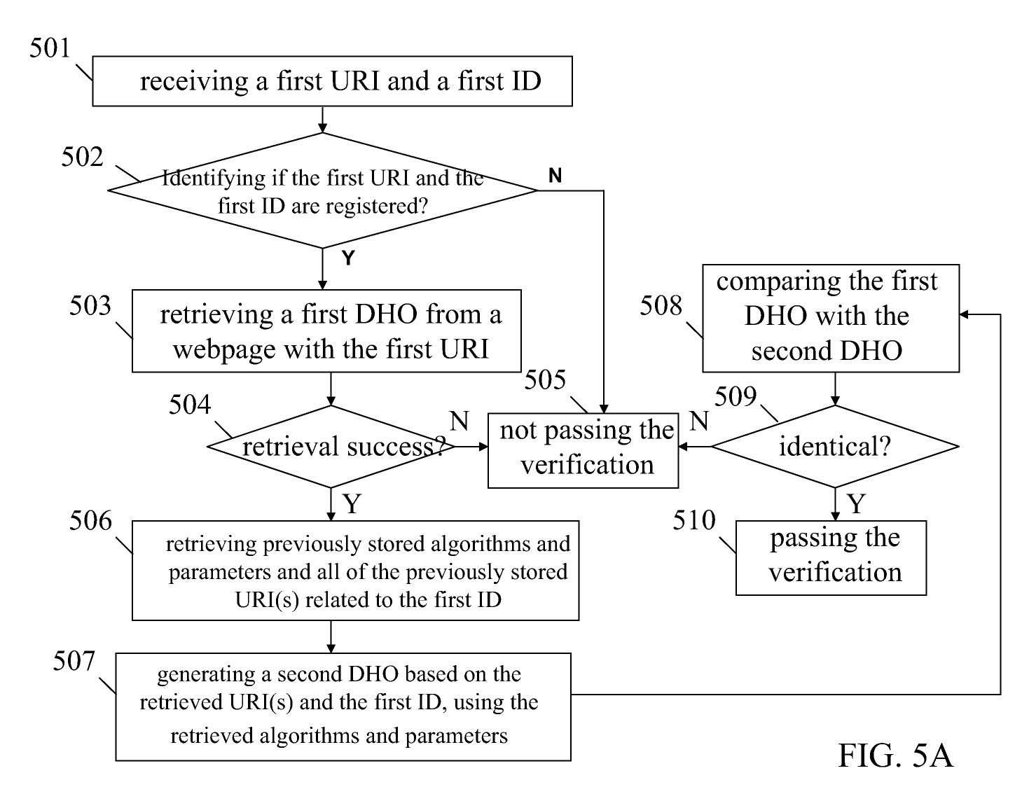

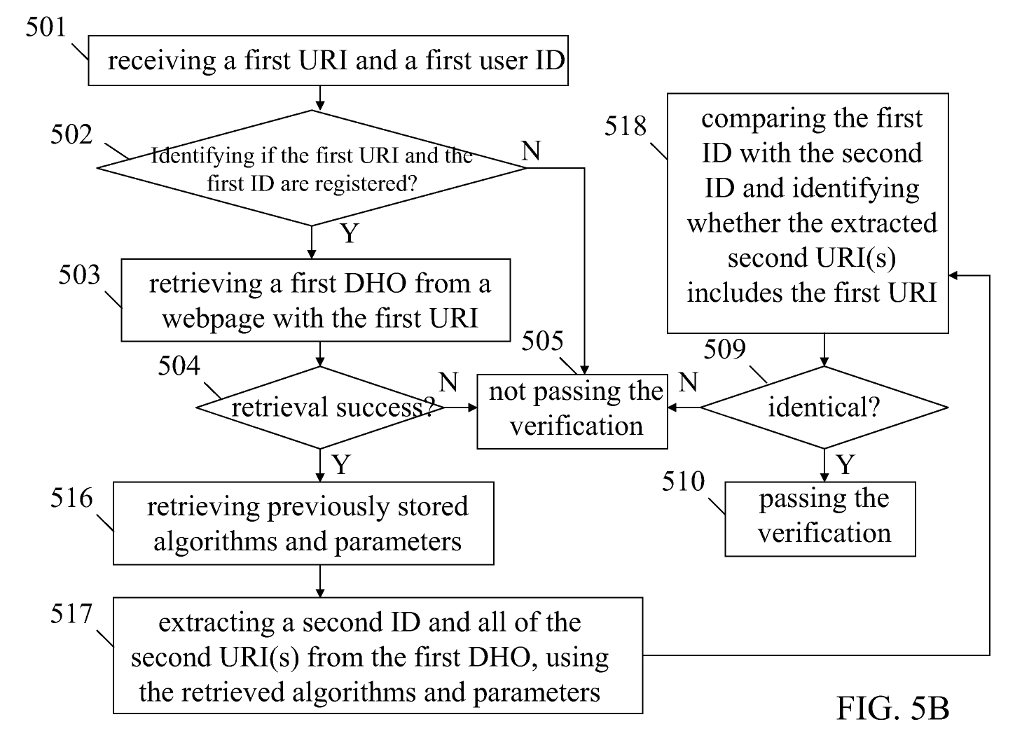

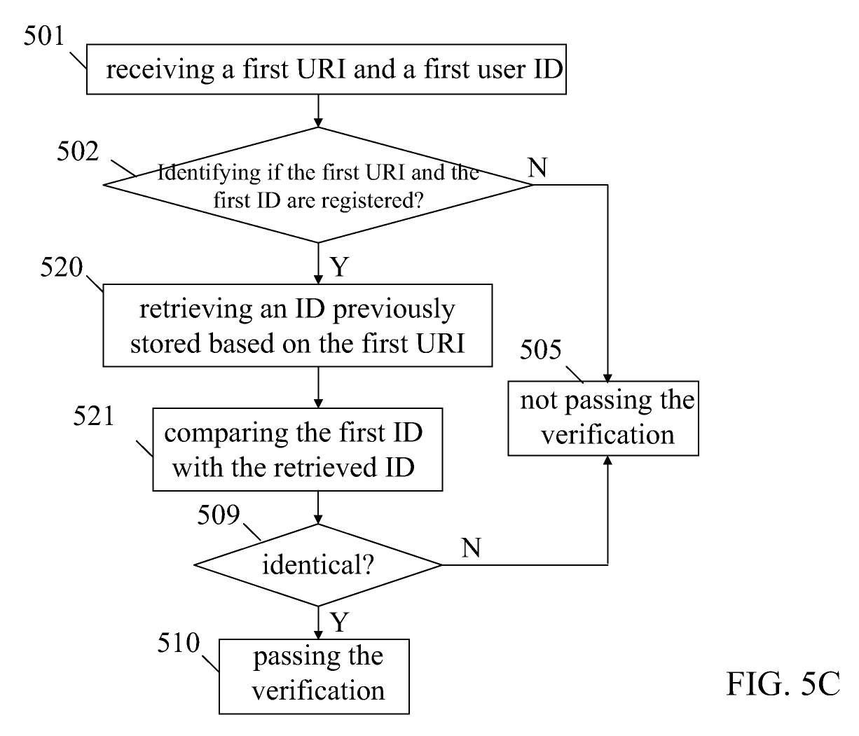

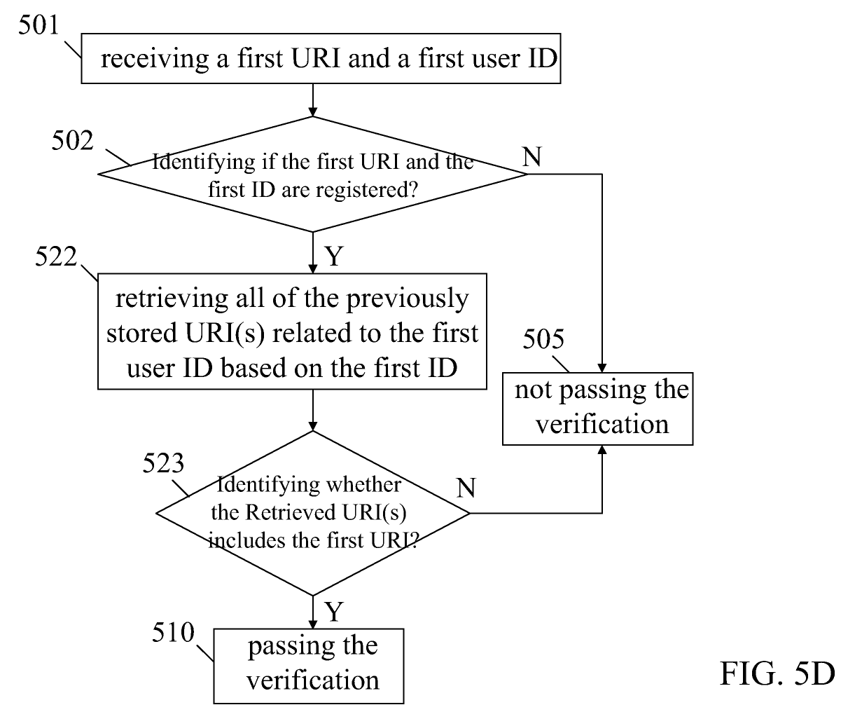

FIGS. 5A to 5D are flow diagrams illustrating other exemplary methods of webpage verification. To verify the authenticity of a webpage, a second user may send a first URI and a first ID to the server. Referring to FIG. 5A, the first URI and the first ID from the second user may be received by the server at step 501. It may be identified at step 502 whether the first ID and the first URI are registered with the system. If either the first ID or the first URI has not been registered, it may be determined at step 505 that the webpage does not pass the verification. If confirmative, a webpage may be linked using the first URI and then a first DHO, if any, may be retrieved from the webpage at step 503. If at step 504 the retrieval fails, it may be identified at step 505 that the webpage at issue does not pass the verification, which may be for several reasons, such as, for example, the owner of the webpage has not yet placed an authenticated DHO on the webpage, or the integrity of the first DHO has been destroyed. If at step 504 the retrieval succeeds, the algorithms and parameters previously stored and all of the URI(s) related to the first ID may be retrieved at step 506. A second DHO may be generated based on the retrieved URI(s) and the first ID, using the algorithms and parameters at step 507. The first DHO and the second DHO may then be compared with each other at step 508 in an object comparison process. If at step 509 the first DHO and the second DHO are identical, it may be identified at step 510 that the webpage has passed the verification. If not identical, it may be identified at step 505 that the webpage fails to pass the verification.

Referring to FIG. 5B, after step 504, the algorithms and parameters previously stored may be retrieved at step 516. A second ID and all of the second URI(s) in the first DHO may be extracted from the first DHO at step 517, using the algorithms and required parameters. The first ID and the second ID may be compared with each other while the first URI and the extracted second URI(s) may be compared with each other to identify whether the extracted second URI(s) includes the first URI at step 518 in a data comparison process. If at step 509 the first ID and the second user ID are identical and the extracted second URI(s) includes the first URI, it may be identified at step 510 that the webpage has passed the verification. If not identical, it may be identified at step 55 that the webpage fails to pass the verification.

Referring to FIG. 5C, after step 502, an ID previously stored in a memory module of the system may be retrieved based on the first URI at step 520. The retrieved ID and the first ID may then be compared with each other at step 521. If at step 509 the retrieved ID and the first ID are identical, it may be identified at step 510 that the webpage passes the verification. If not identical, it may be identified that the webpage fails to pass the verification at step 505.

Referring to FIG. 5D, after step 502, all of the URI(s) related to the first user ID may be retrieved from the memory module of the system based on the first ID at step 522. At step 523, it may be identified whether the retrieved URI(s) includes the first URI. If confirmative, it may be identified at step 510 that the webpage passes the verification. If not, it may be identified at step 505 that the webpage fails to pass the verification.

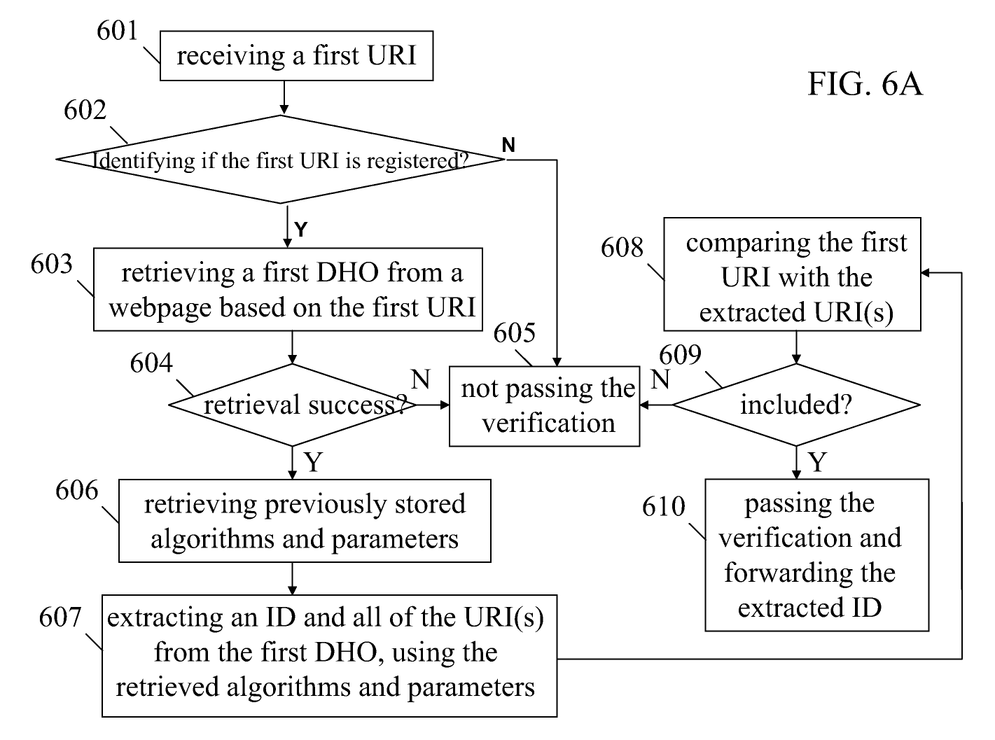

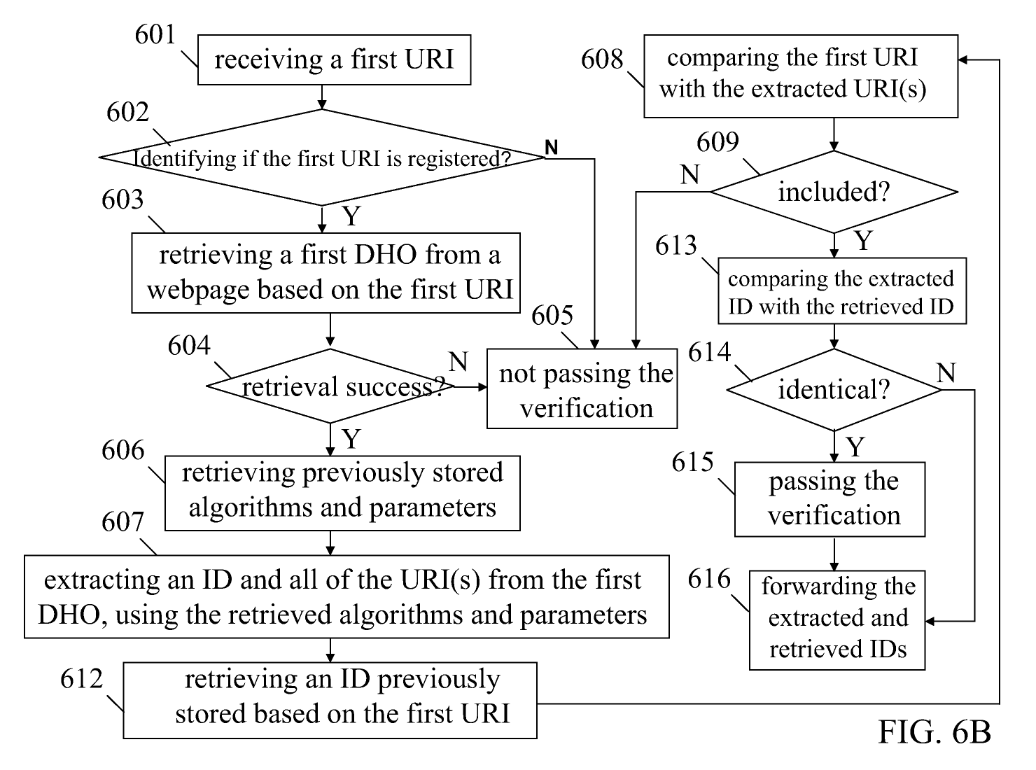

FIGS. 6A and 6B are flow diagrams illustrating still other exemplary methods of webpage verification. To make an inquiry to the system about the owner of a webpage, a second user may send only a first URI to the server. Referring to FIG. 6A, the first URI from the second user may be received by the server at step 601. It may be identified at step 602 whether the first URI is registered with the system. If not, it may be determined at step 605 that the webpage does not pass the verification. If confirmative, a webpage may be linked using the first URI and then a first DHO, if any, may be retrieved from the webpage at step 603. If at step 604 the retrieval fails, it may be identified at step 605 that the webpage at issue does not pass the verification. If at step 604 the retrieval succeeds, the algorithms and required parameters previously stored may be retrieved at step 606.

Next, an ID and all of the URI(s) in the first DHO may be extracted from the first DHO at step 607, using the algorithms and parameters. The first URI and the extracted URI(s) may be compared with each other at step 608. If at step 609 the extracted URI(s) does not include the first URI, it may be identified at step 605 that the webpage fails to pass the verification. If the extracted URI(s) includes the first URI, it may be identified at step 610 that the webpage has passed the verification. Furthermore, the extracted ID may be forwarded to the second user as a response to the inquiry, which may indicate that the webpage with the first URI belongs to a user with the extracted ID.

Referring to FIG. 6B, after step 607, an ID may be retrieved from a memory module based on the first URI at step 612. Next, the first URI and the extracted URI(s) may be compared with each other at step 608 in order to identify whether the extracted URI(s) includes the first URI at step 609. If not, the webpage with the first URI does not pass the verification. If confirmative, the extracted ID and the retrieved ID may be compared with each other at step 613 in order to identify whether they are identical at step 614. If confirmative, it may then be identified that the webpage with the first URL passes the verification. The extracted and retrieved IDs may be forwarded at step 616 to the second user as a response to the second user's inquiry.

In describing representative examples of embodiments of the present invention, the specification may have presented the method and/or process of operating the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

We claim:

1. A system for webpage verification, the system comprising:
an authentication module configured to authenticate a user identifier if the said user identifier is unique in the system, the said user identifier being related to the identity of a user;
a data-hiding module configured to generate a first data-hidden object based on the said user identifier, at least one webpage identifier and a base object in accordance with a data-hiding algorithm, each of the at least one webpage identifiers being related to the identity of one of at least one webpage of the user;
a memory module to store at least one of the said user identifier, the at least one webpage identifier, the base object, and the required parameters of data hiding algorithm; and
a verification module configured to retrieve the first data-hidden object from one of the at least one webpage based on one of the at least one webpage identifiers, retrieve the said user identifier and all of the webpage identifiers from the memory module based on the one webpage identifier, generate a second data-hidden object based on the retrieved webpage identifiers, the said retrieved user identifier and the base object, and compare the first data-hidden object with the second data-hidden object.

2. The system of claim 1, wherein the data-hiding module is configured to generate a signature based on the said user identifier and the at least one webpage identifier.

3. The system of claim 2, wherein the data-hiding module is configured to generate the first data-hidden object based on the signature and the base object.

4. The system of claim 2, wherein the verification module is configured to extract a signature from the first data-hidden object retrieved from the one webpage based on the one webpage identifier and compare the signature generated by the data-hiding module with the signature extracted from the first data-hidden object.

5. The system of claim 1, wherein the verification module is configured to extract the said user identifier from the first data-hidden object retrieved from the one webpage based on the one webpage identifier and compare the said user identifier retrieved from the memory module with the said user identifier extracted from the first data-hidden object.

6. The system of claim 1, wherein the verification module is configured to extract all of the webpage identifiers from the first data-hidden object retrieved from the one webpage based on the one webpage identifier, and identify whether the webpage identifiers extracted from the first data-hidden object include the one webpage identifier.

7. The system of claim 1, wherein the verification module is configured to receive a first user identifier and a first webpage identifier and retrieve a third data-hidden object from a webpage with the first webpage identifier.

8. The system of claim 7, wherein the verification module is configured to retrieve all of the webpage identifiers related to the said first user identifier from the memory module, generate a fourth data-hidden object based on the said first user identifier and the retrieved webpage identifiers and compare the third data-hidden object with the fourth data-hidden object.

9. The system of claim 7, wherein the verification module is configured to extract a user identifier from the third data-hidden object and compare the said first user identifier with the user identifier extracted from the third data-hidden object.

10. The system of claim 7, wherein the verification module is configured to extract all of the webpage identifiers from the third data-hidden object and identify whether the extracted webpage identifiers include the first webpage identifier.

11. The system of claim 7, wherein the verification module is configured to retrieve a user identifier from the memory module based on the first webpage identifier and compare the said first user identifier with the user identifier retrieved from the memory module.

12. The system of claim 7, wherein the verification module is configured to retrieve all of the webpage identifiers related to the said first user identifier from the memory module and identify whether the retrieved webpage identifiers include the first webpage identifier.

13. The system of claim 1, wherein the verification module is configured to receive a first webpage identifier and retrieve a fifth data-hidden object from a webpage with the first webpage identifier.

14. The system of claim 13, wherein the verification module is configured to extract a user identifier and all of the webpage identifiers from the fifth data-hidden object and identify whether the webpage identifiers extracted from the fifth data-hidden object include the first webpage identifier.

15. The system of claim 14, wherein the verification module is configured to forward the user identifier extracted from the fifth data-hidden object to a user if the extracted webpage identifiers include the first webpage identifier.

16. The system of claim 15, wherein the verification module is configured to compare the user identifier retrieved from the memory module with the user identifier extracted from the fifth data-hidden object.

17. A system for webpage verification, the system comprising:
an authentication module configured to authenticate a user identifier if the said user identifier is unique in the system, the said user identifier being related to the identity of a user;
a data-hiding module configured to generate a first data-hidden object based on the said user identifier, at least one webpage identifier and a base object in accordance with a data-hiding algorithm, each of the at least one webpage identifiers being related to the identity of one of at least one webpage of the user;
a memory module to store at least one of the said user identifier, the at least one webpage identifier, the base object, and the required parameters of data-hiding algorithm; and
a verification module configured to retrieve the first data-hidden object from one of the at least one webpage based on one of the at least one webpage identifier, extract a user identifier and all of the webpage identifiers from the first data-hidden object, retrieve a user identifier from the memory module based on the one webpage identifier and compare the said extracted user identifier with the said retrieved user identifier and identify whether the extracted webpage identifiers include the one webpage identifier.

18. The system of claim 17, wherein the data-hiding module is configured to generate a signature based on the said user identifier and the at least one webpage identifier.

19. The system of claim 18, wherein the data-hiding module is configured to generate the first data-hidden object based on the signature and the base object.

20. The system of claim 17, wherein the verification module is configured to retrieve all of the webpage identifiers related to the said retrieved user identifier, generate a second data-hidden object based on the retrieved webpage identifiers, the said retrieved user identifier and the base object, and compare the first data-hidden object with the second data-hidden object.

21. The system of claim 17, wherein the verification module is configured to receive a first user identifier and a first webpage identifier and retrieve a third data-hidden object from a webpage with the first webpage identifier.

22. The system of claim 21, wherein the verification module is configured to retrieve all of the webpage identifiers related to the said first user identifier from the memory module, generate a fourth data-hidden object based on the said first user identifier and the retrieved webpage identifiers and compare the third data-hidden object with the fourth data-hidden object.

23. The system of claim 21, wherein the verification module is configured to extract a user identifier from the third data-hidden object and compare the said first user identifier with the said user identifier extracted from the third data-hidden object.

24. The system of claim 21, wherein the verification module is configured to extract all of the webpage identifiers from the third data-hidden object and identify whether the extracted webpage identifiers include the first webpage identifier.

25. The system of claim 21, wherein the verification module is configured to retrieve a user identifier from the memory module based on the first webpage identifier and compare the said first user identifier with the said user identifier retrieved from the memory module.

26. The system of claim 21, wherein the verification module is configured to retrieve all of the webpage identifiers related to the said first user identifier from the memory module and identify whether the retrieved webpage identifiers include the first webpage identifier.

27. The system of claim 17, wherein the verification module is configured to receive a first webpage identifier and retrieve a fifth data-hidden object from a webpage with the first webpage identifier.

28. The system of claim 27, wherein the verification module is configured to extract a user identifier and all of the webpage identifiers from the fifth data-hidden object and identify whether the webpage identifiers extracted from the fifth data-hidden object include the first webpage identifier.

29. The system of claim 28, wherein the verification module is configured to forward the said user identifier extracted from the fifth data-hidden object to a user if the extracted webpage identifiers include the first webpage identifier.

30. The system of claim 29, wherein the verification module is configured to compare the said user identifier retrieved from the memory module with the said user identifier extracted from the fifth data-hidden object.

31. A system for webpage verification, the system comprising:
an authentication module configured to authenticate a user identifier if the said user identifier is unique in the system, the said user identifier being related to the identity of a user;
a data-hiding module configured to generate a first data-hidden object based on the said user identifier, at least one webpage identifier and a base object in accordance with a data-hiding algorithm, each of the at least one webpage identifiers being related to the identity of one of at least one webpage of the user; and
a verification module configured to receive a first webpage identifier, retrieve a second data-hidden object from a webpage based on the first webpage identifier, extract all of the webpage identifiers from the second data-hidden object, and identify whether the webpage identifiers extracted from the second data-hidden object include the first webpage identifier.

32. The system of claim 31, wherein the verification module is configured to extract a user identifier from the second data-hidden object and forward the said extracted user identifier to a user if the webpage identifiers extracted from the second data-hidden object include the first webpage identifier.

33. The system of claim 31 further comprising a memory module to store at least one of the said user identifier, the at least one webpage identifier, the base object, and the required parameters of data-hiding algorithm.

34. The system of claim 33, wherein the verification module is configured to extract a user identifier from the second data-hidden object, retrieve a user identifier from the memory module based on the first webpage identifier, and compare the said extracted user identifier with the retrieved user identifier.

35. The system of claim 34, wherein the verification module is configured to forward at least one of the said extracted user identifier or the retrieved user identifier to a user.
